(19) United States
(12) Patent Application Publication
(10) Pub. No.: US 2025/0189940 A1
(43) Pub. Date: Jun. 12, 2025

(54) METHOD AND DEVICE FOR TRAINING A MACHINE LEARNING SYSTEM

(71) Applicant: Robert Bosch GmbH, Stuttgart (DE)

(72) Inventors: Felix Berkel, Schifferstadt (DE); Kim Peter Wabersich, Schwaebisch Gmuend (DE)

(21) Appl. No.: 18/955,143

(22) Filed: Nov. 21, 2024

(30) Foreign Application Priority Data
Nov. 29, 2023 (DE) 10 2023 211 942.0

(51) Int. Cl. G05B 13/02; G05B 13/04

(52) U.S. Cl. CPC G05B 13/027; G05B 13/048

(57) ABSTRACT

A computer-implemented method for training a machine learning system a model-predictive control of a technical system. The machine learning system is configured, with respect to an operating state and/or an environmental state of the technical system to be controlled, to ascertain a value that characterizes a quality of the state. The method includes ascertaining a plurality of operating states and/or environmental states of the technical system to be controlled; ascertaining a quality value of a state of the plurality of operating states and/or environmental states, wherein the quality value characterizes a quality of the state with respect to a model-predictive control; and training the machine learning system through supervised training of the machine learning system, wherein the state is used as input of the machine learning system and the ascertained quality value is used as the desired output of the machine learning system.

### FIELD

The present invention relates to a method for training a machine learning system, a method for model-predictive control of a technical system, a training system, a control system, a computer program and a machine-readable storage medium.

### BACKGROUND INFORMATION

Zeilinger et al. “Soft Constrained Model Predictive Control With Robust Stability Guarantees,” 2014, ieeexplore.ieee.org/abstract/document/6730917/describes a method for model-predictive control of a technical system.

### BACKGROUND INFORM

Model-predictive control (MPC) is a key method for controlling technical systems. In conventional approaches to model-predictive control, an optimal control problem is formulated and solved at each sampling time. In this optimization problem, the future behavior of the system is predicted over a finite time horizon, starting from a current state measurement of the system and using a model of the system. An advantage of model-predictive control over other advanced control techniques is that model-predictive control can optimally handle systems with multiple inputs and outputs, and system limitations can be systematically taken into account. Both advantages are used, for example, in the motion control of vehicles. For example, the vehicle must comply with road boundaries, and steering, acceleration and braking must be coordinated in order to ensure safe and efficient operation. Model-predictive control has proven its high level of performance in many studies while offering strict safety guarantees.

When using model-predictive control, an optimal control problem is typically defined at a current point in time and state, which problem, by using a model of the system to be controlled, ascertains an optimal sequence of control signals of the system for a finite number of future states. For this purpose, an optimization problem is typically solved at each point in time and thus for each state, wherein optimization is carried out via (or with respect to) the control signals. The main challenge arises from the requirement that the optimization problem for the control of technical systems must be solved in real time in order to be able to ensure sufficiently precise control.

Conventional approaches to solving the optimization problem work iteratively. A disadvantage of these approaches is that the number of available iterations is typically not sufficient to determine an exact solution to the optimization problem while remaining real-time capable. The effects of applying a control signal that was ascertained on the basis of such a suboptimal solution to the optimization problem generally do not allow estimating how the system to be controlled will behave, in particular with regard to safety-critical behavior of the system.

### SUMMARY

The inventors were surprised to discover that the solution to the optimization problem for a model-predictive control can be approximated extremely precisely using machine learning methods. This makes possible an accurate determination of the solution at runtime of a model-predictive control. The inventors were furthermore able to determine that, by approximating an adapted optimization problem with slack variables, a stability from control signal to state of a technical system can be ensured and it can be ensured that the secondary conditions of the model-predictive control defined in the original optimization problem are met.

In a first aspect, the present invention relates to a computer-implemented method for training a machine learning system for use in a model-predictive control of a technical system, wherein the machine learning system is designed, with respect to an operating state and/or an environmental state of the technical system to be controlled, to ascertain a value that characterizes a quality of the state. According to an example embodiment of the present invention, the method comprises the following steps:
ascertaining a plurality of operating states and/or environmental states of the technical system to be controlled;
ascertaining a quality value of a state of the plurality of operating states and/or environmental states, wherein the quality value characterizes a quality of the state with respect to a model-predictive control;
training the machine learning system through supervised training of the machine learning system, wherein the state is used as input of the machine learning system and the ascertained quality value is used as the desired output of the machine learning system.

Operating states and/or system states are also simply referred to below as states. In the sense of control technology, a state of a technical system can in particular be understood as completely measurable or at least observable. For example, it is possible that at least parts of a state are measured by means of sensors of the system to be controlled or are derived on the basis of sensor recordings (also referred to as an indirect measurement). For example, it is possible that a mobile robot that records images of its environment by means of a camera is to be controlled. On the basis of these images, it can be ascertained, as at least part of a state of the robot, how far the robot deviates from a driving trajectory defined in the robot's environment.

According to an example embodiment of the present invention, after training, the machine learning system can be used, in particular within a control policy, to evaluate the quality of a future state. On the basis of this evaluation, it is then possible to select a control signal for the technical system that has the best quality with respect to a plurality of possible control signals.

The training method can be understood in such a way that training data are first collected, which are then used to train the machine learning system in a supervised manner. Supervised training generally uses data sets of tuples, wherein each tuple comprises an input signal and a desired output signal. During supervised training, the machine learning system is adapted in such a way that it outputs an output signal that is as close as possible to the desired output signal when the machine learning system receives the input signal as input. For the training method, a state can be understood as an input signal which is used for training. Such an input signal can be ascertained in particular by recording states of the system during operation of the system. Alternatively, it is also possible for the states to be generated synthetically, for example on the basis of a rasterization of physically meaningful values of a state.

For training, a quality measure is then ascertained for at least one state. The quality measure can be understood as an annotation or desired output signal in the sense of supervised training. The quality measure is ascertained with respect to a model-predictive control.

In particular, the quality value can be ascertained on the basis of a value function of the model-predictive control, wherein the value function ascertains a quality of the state with respect to a state and the value function furthermore comprises secondary conditions, wherein a secondary condition characterizes a physical limitation of the state and/or a secondary condition characterizes a limitation of a control signal which the model-predictive control can select.

For example, a state can characterize an acceleration of the system, wherein the acceleration cannot exceed a certain value due to the motors used in the system. In this case, the secondary condition can characterize this value.

According to an example embodiment of the present invention, the states used for the method can be ascertained in particular by the system which is to be controlled model-predictively on the basis of the machine learning system. For example, the system can be put into a test mode in which a different control is used, and typical conditions can be ascertained by means of the test mode. The system can also be placed under unusual operating conditions in order to ascertain states that simulate the limit ranges of a typical control. Alternatively or additionally, it is also possible to ascertain possible states of the system by simulation, e.g., by means of a computer simulation of the system. The possibilities mentioned here for ascertaining the states can also be applied to structurally identical or structurally similar systems. For example, it is possible to use a prototype or a system that is structurally identical or structurally similar to the system to be controlled, in order to ascertain conditions that are also likely to occur in the system in this or a similar manner.

In particular, a state can be understood as a set of values that describe physical parameters of the system and/or of an environment of the system.

Preferably, a state of the system can be characterized by a vector of real numbers. The expression “ascertaining a plurality of operating states and/or environmental states of the technical system to be controlled” can thus also be equivalently replaced by “ascertaining a plurality of states of the technical system to be controlled.” Each state of the plurality of states can be understood as a vector of values, wherein each value characterizes an operating state or environmental state of the system.

The value function can in particular characterize the solution of an optimization of a convex function, wherein the function characterizes the costs of a control of the technical problem, i.e., the function can be understood as a cost function.

According to an example embodiment of the present invention, advantageously, the solution of the optimization can be ascertained (offline) before the model-predictive control of the system is used. This makes it possible to determine the quality value very precisely, since there are no time requirements for the real-time capability of the optimization.

The machine learning method is subsequently advantageously trained to predict a quality value with respect to a state. This prediction can be understood as an approximate solution of the optimization problem. The inventors were able to determine that, even when machine learning systems with low requirements for resources and computing capacities are used, the prediction of the quality value is still accurate enough to carry out a model-predictive control.

The optimization can in particular be a minimization, wherein a quality value ascertained by the minimization can be understood to mean that a lower value has a higher quality. The quality value can therefore be understood as a cost value, wherein lower costs have a higher quality; in other words, a state with lower costs is better than a second state with higher costs.

In various embodiments of the present invention, the value function may comprise a secondary condition that permits a numerical deviation of a state from a physical limitation by means of a slack variable.

By means of the slack variable, the secondary conditions of the optimization problem are relaxed in the sense of a mathematical optimization. This makes it advantageously possible to ascertain a sufficiently accurate solution to the optimization problem even for sophisticated control tasks. The inventors were able to determine that this improves the performance of the machine learning system since, due to the relaxation, the slack variables make possible a higher generalization capability of the machine learning system. In particular, it is also possible that there are multiple secondary conditions with slack variables.

According to an example embodiment of the present invention, in particular, it is advantageous that the cost function comprises a term that characterizes a sum of magnitudes of the slack variables. Advantageously, the solution of the optimization problem can thus take into account that slack variables cannot become arbitrarily large and the ascertained solutions are thus far outside the permissible limitations of the secondary conditions. In particular, the term can be multiplied by a factor that can be understood as a hyperparameter of the optimization problem and controls the influence of the slack variables.

In vectorial states, the limitations and the slack variables can also, in particular, be in the form of vectors. In these cases, the term of the cost function can in particular comprise a sum of the lengths or squared lengths of the slack variables.

In particular, it is possible that a secondary condition of the optimization problem furthermore provides a factor that amplifies the physical limitation on the state.

The inventors were advantageously able to determine that amplifying the limitation results in the subsequent model-predictive control for which the machine learning system is used becoming more robust against errors that arise from the approximation of the optimization problem by the machine learning system.

In particular, the factor used for the slack variables and the factor used for the physical limitation can be used to show that the secondary conditions are met, even in the case of errors that occur when the machine learning system approximates the quality value, if, instead of an exact solution to the optimization problem, the machine learning system is used to ascertain the quality value in the model-predictive control.

According to an example embodiment of the present invention, the optimization problem is preferably described by the formula

$$V ( x ) = {min}_{u {.}_{\vert k} , x {.}_{\vert k} , ξ {.}_{\vert k}} J ( u {.}_{\vert k} , x {.}_{\vert k} , ξ {.}_{\vert k} )$$

$$and the N {x}_{0 \vert k} = x ( k ) ,$$

$${x}_{N \vert k} ∈ α {X}_{f}$$

$$α {X}_{f} ⊆ \{ x \vert {H}_{x} x < {h}_{x} ( 1 - η ) + {ξ}_{N \vert k} \} ,$$

$$0 \leq α \leq 1 ,$$

$$∀ i ∈ \{ 0 , … N - 1 \} :$$

$$0 \leq {ξ}_{i \vert k} ,$$

$${x}_{i + 1 \vert k} = {Ax}_{i \vert k} + {Bu}_{i \vert k} ,$$

$${H}_{u} {u}_{i \vert k} \leq {h}_{u} ,$$

$${H}_{x} {x}_{i \vert k} \leq {h}_{x} ( 1 - η ) + {ξ}_{i \vert k} + {ξ}_{N \vert k}$$

Starting from a current state x, the optimization variables are: the sequence of control signals of the system u._{|k}={u_{i|k}}ᵢ₌₀^{N-1} that was determined by the model-predictive control, the sequence of subsequent states x._{|k}={x_{i|k}}ᵢ₌₀^{N} that was predicted from the sequence of control signals, and a sequence of optional but preferred slack variables ξ._{|k}={ξ_{i|k}}ᵢ₌₀^{N} with which the secondary conditions of the optimization problem can be relaxed. The cost function J is preferably characterized by the formula

$$J ( u {.}_{\vert k} , x {.}_{\vert k} , ξ {.}_{\vert k} ) = {x}^{T} Px + ρ ‖ {ξ}_{N \vert k} ‖ + {\sum }_{i = 0}^{N - 1} l ( {x}_{i \vert k} , {u}_{i \vert k} ) + ρ ‖ {ξ}_{i \vert k} + {ξ}_{N \vert k} ‖ ,$$

$$l ( x , u ) = {x}^{T} Qx + {u}^{T} Ru .$$

The matrices Hᵤ, Hₓ, Q and R are hyperparameters of the optimization problem. The subscript |k indicates that reference is made to a point in time from a point in time k. For example, x_{i|k} is the predicted state for the point in time i, predicted at the point in time k. The secondary condition Hᵤu_{i|k}≤hᵤ characterizes a limitation of the control signal at any point in time i from the point in time k. The secondary condition

$${H}_{x} {x}_{i \vert k} \leq {h}_{x} ( 1 - η ) + {ξ}_{i \vert k} + {ξ}_{N \vert k}$$

represents a preferred secondary condition that further amplifies a limitation hₓ of a state x_{i|k} via the factor η. The factors η and ρ can be understood as interacting hyperparameters that weigh the degree of relaxation of the optimization problem (via ρ) against a robustness in relation to the approximation error (via η). The formula x_{i+1|k}=Ax_{i|k}+Bu_{i|k} characterizes a linear model of the system to be controlled, which model predicts a state transition from a point in time i to a subsequent point in time i+1 on the basis of a current state x_{i|k} and a control signal u_{i|k}, i.e., predicts the subsequent state. The variable N characterizes the prediction horizon of the model-predictive control; in other words, how far the model-predictive control looks into the future.

According to an example embodiment of the present invention, in the method, it can be provided that the first quality value corresponds to the result of the value function at the location of the state. In other words, it can be provided that the machine learning system predicts the result of the value function in a single step (end-to-end).

Preferably, however, it can be provided that the machine learning system predicts two parts of the value function and thus divides the prediction.

In particular, it can therefore be provided that the first quality value corresponds to a first part of the value function at the location of the state, wherein the first part does not contain any slack variables, and that the machine learning system furthermore ascertains a second quality value, wherein the second quality value corresponds to a second part of the value function at the location of the state which contains slack variables, and that, in the training step, the second quality value is used as another desired output of the machine learning system.

The inventors were able to determine that the value function generally behaves in such a way that, from a certain state value (which depends on the system to be controlled), the value function has strongly increasing values, since the slack variables for this part of the state space become “active,” i.e., the optimization must use the slack variables in order to solve the optimization. This results in a greatly increased local Lipschitz constant and curvature of the function, which makes it difficult for the machine learning system to learn the value function.

According to an example embodiment of the present invention, advantageously, dividing the value function into a part with slack variables and a part without slack variables allows two separate parts of the value function to be learned, which together describe the value function, wherein each separate part has locally small Lipschitz constants and curvature. This greatly simplifies the learning problem, and the machine learning system can better predict the value of the value function for a given state.

For the training, the optimization problem should preferably be solved first, and the division of the value function should only be carried out with the values thus obtained. In other words, training data can preferably be ascertained by selecting a state value at a time, solving the optimization problem for this state value and subsequently, with regard to the obtained value, dividing the value function into a part that contains slack variables and a part that does not contain slack variables.

Preferably, the first quality value can therefore be ascertained according to the following formula:

$${V}^{perf} ( x ) = {x}^{T} Px + {\sum }_{i = 0}^{N - 1} l ( {x}_{i \vert k} , {u}_{i \vert k} ) ,$$

where the value x here represents the value ascertained by optimizing V(x).

The second quality value can preferably be described by the formula

$${V}^{slack} ( x ) = ρ ‖ {ξ}_{N \vert k} ‖ + {\sum }_{i = 0}^{N - 1} ρ ‖ {ξ}_{i \vert k} + {ξ}_{N \vert k} ‖ ,$$

where x again represents the value ascertained by optimizing V(x).

It can also preferably be provided that the machine learning system comprises two machine learning models, in particular two neural networks, wherein a first model of the two models is configured to predict the first quality value on the basis of the state as input of the first model and a second model of the two models is configured to predict the second quality value on the basis of the state as input of the second model.

In other words, in each case, a model preferably exists that makes it possible to predict the first or second quality value. As explained above, the inventors were able to determine that the two models are in each case easier to train individually than is a single model for predicting the value of the value function.

The two models do not necessarily have to be on the same computer but can also be on different computers in a distributed environment. The machine learning system is therefore not limited to a single computer but can also be provided by a distributed system.

According to an example embodiment of the present invention, alternatively, it is also possible for the machine learning system to comprise a machine learning model, in particular a neural network, wherein the model is configured to predict the first quality value and the second quality value.

If the model is designed as a neural network, it can in particular comprise two so-called heads, each of which predicts the first or second quality value.

The machine learning system, which is configured to predict two quality values, can in particular be trained on the basis of a first loss function and a second loss function, wherein the first loss function characterizes a difference between a prediction of the first quality value and the first quality value and the second loss function characterizes a difference between the prediction of the second quality value and the second quality value.

In other words, the machine learning system can be trained on the first and second quality values in a supervised manner, with there being one loss function per quality value.

A data set of pairs of a state and a quality value ascertained for the state by optimization can in particular be used for training. For the embodiments with two quality values, after optimization, a quality value for parts of the value function with slack variables and a quality value for parts of the value function without slack variables can be ascertained. In these cases, the data set preferably consists of tuples of three elements: state value, first quality value and second quality value.

Alternatively, according to an example embodiment of the present invention, the data set can also be divided into a data set of tuples, each consisting of a state value and a first quality value, and a further data set of tuples, each consisting of a state value and a second quality value.

In particular, the second loss function, i.e., the loss function with respect to the quality value that includes slack variable components, can be characterized by the formula:

$${ℒ}^{slack} = {\sum }_{( x , y ) ∈ {D}^{slack , +}} \vert \vert {\hat{V}}^{slack} ( x ) - y \vert \vert + {\sum }_{( x , y ) ∈ {D}^{slack , 0}} c \cdot max ( 0 , {\hat{V}}^{slack} ( x ) ) ,$$

where (x,y)∈D^{slack,+} characterizes all tuples that have a state value x and a positive second quality value y, and (x,y)∈D^{slack,0} characterizes all tuples that have a state value x and second quality value y equal to zero. In other words, the subset D^{slack,0} comprises states for which the slack variables are not active.

Advantageously, the neural network is thus not penalized if the output of the second quality value is negative. The inventors were able to determine that this allows further simplification of the model to be learned by the machine learning system for the second quality value, as a result of which the second quality value can be predicted even more precisely.

In the various example embodiments of the training method of the present invention, it is possible that, in the training step, the machine learning system is trained at least until an approximation quality criterion is met, wherein the approximation quality criterion characterizes a magnitude of a difference between a value ascertained for a state by the value function and a value ascertained for the state by the machine learning system.

The approximation quality criterion can be understood to mean that the machine learning system is evaluated in terms of the extent to which it is able to ascertain the same values for a state as those ascertained by means of the value function. For as long as the approximation is not yet good enough, training of the machine learning system can be continued. If the quality criterion has not yet been met after a predefined number of iterations, it is also possible to collect additional training data for the method or to increase the number of degrees of freedom of the machine learning system, for example by increasing the number of parameters of the machine learning system. If a neural network is used as a machine learning system, an architecture of the neural network can in particular be changed in such a way that the neural network becomes deeper and/or layers of the neural network have more parameters.

Advantageously, the inventors were able to determine that, if the approximation quality criterion is met, it can be ensured that, when using the machine learning system, the secondary conditions of the value function are met despite approximation errors. This has the effect that the approximation found by means of the machine learning system makes a demonstrably secure control of the technical system possible.

In a further aspect, the present invention relates to a computer-implemented method for model-predictive control of a technical system. According to an example embodiment of the present invention, the method comprises the following steps:
ascertaining an operating state and/or environmental state of the system;
ascertaining a control signal for the system, wherein the control signal is ascertained on the basis of a control law, wherein the control law includes a term \tilde{V}_{MPC}(f(x,u)), where \tilde{V}_{MPC} characterizes an output of a machine learning system when it receives the input f(x,u), where f is a model, preferably a linear model, of the system and predicts a next operating state and/or system state of the system on the basis of the ascertained operating state and/or environmental state x and a control signal u, wherein the machine learning system has furthermore been trained according to the training method;
controlling the system by means of the ascertained control signal.

The above-described method for model-predictive control describes the case in which the machine learning system predicts the result of the value function directly, i.e., end-to-end.

The concept of a control law is generally better known by its English term ‘policy.’ Essentially, the policy can be understood as a function that ascertains a control signal with respect to a state of the system to be controlled, by means of which control signal the system is to be controlled.

In the model-predictive control method, the policy can in particular be formulated as a further optimization problem. The control signal which, when applied to the current state, leads to a state with the highest possible quality can be selected as the control signal.

For ascertaining the next state to which a control signal leads on the basis of a current state, a linear model of the form

$$x ( k + 1 ) = f ( x ( k ) , u ( k ) ) = Ax ( k ) + Bu ( k )$$

can in particular be used, where x(k) is a state at a point in time k, u(k) is a control signal at the point in time k, and A and B are matrices.

Advantageously, by using the machine learning system, the execution of the method can be significantly accelerated since it is no longer necessary to carry out an optimization under secondary conditions in order to ascertain the quality of a state, but the quality can rather be determined by means of the machine learning system.

The optimization problem in the model-predictive control method can furthermore include a term that characterizes a magnitude of the control signal.

Advantageously, a quality of the state to be achieved and an influence of the control on the system can thus be weighed up if both terms appear in the optimization problem. This prevents the system from oscillating due to excessively large control signals but, for example when controlling motors, can also lead to smoother control, which contributes to less load and wear on the motors and thus on the system to be controlled.

In a further aspect, the present invention relates to a computer-implemented method for model-predictive control of a technical system. According to an example embodiment of the present invention, the method comprises the following steps:
ascertaining an operating state and/or environmental state of the system;
ascertaining a control signal for the system, wherein the control signal is ascertained on the basis of a control law, wherein the control law includes a term \tilde{V}(f(x,u)), wherein \tilde{V} is ascertained according to the formula

$$\tilde{V} ( f ( x , u ) ) = {\tilde{V}}^{p e r f} ( f ( x , u ) ) + max ( 0 , {\tilde{V}}^{s l a c k} ( f ( x , u ) ) ,$$

where \tilde{V}^{perf}(f(x,u)) characterizes a first quality value output by a machine learning system for the input f(x,u) and \tilde{V}^{slack}(f(x,u)) characterizes a second quality value output by the machine learning system for the same input, where f is a model, preferably a linear model, of the system and predicts a next operating state and/or system state of the system on the basis of the ascertained operating state and/or environmental state x and a control signal u, wherein the machine learning system has furthermore been trained according to the above-described method for training a machine learning system to output the first quality value and the second quality value.

The method is essentially equivalent to the above-described predictive control method, but for incorporating the special structure of the machine learning system for outputting the first quality value and for outputting the second quality value.

In the example methods of the present invention described above, the machine learning system can in particular be or comprise a neural network.

The inventors were able to determine that the use of neural networks leads to a best approximation of the quality of a state. However, it is also possible to use other machine learning methods. In particular, in the case of simpler control tasks with few secondary conditions or a small state space or when used on embedded hardware, methods that are even more resource-efficient, such as linear regression or support-vector machines, can be used.

Example embodiments of the present invention will be explained in detail below with reference to the figures.

### BRIEF DESCRIPTION OF THE DRAWINGS

FIG. 1 schematically shows a method for training a machine learning system, according to an example embodiment of the present invention.

FIG. 2 schematically shows a training system, according to an example embodiment of the present invention.

FIG. 3 schematically shows a structure of a control system for controlling a technical system, according to an example embodiment of the present invention.

FIG. 4 schematically shows an exemplary embodiment for controlling an at least partially autonomous robot, according to the present invention.

FIG. 5 schematically shows an exemplary embodiment for controlling a manufacturing system, according to the present invention.

### DETAILED DESCRIPTION OF EXAMPLE EMBODIMENTS

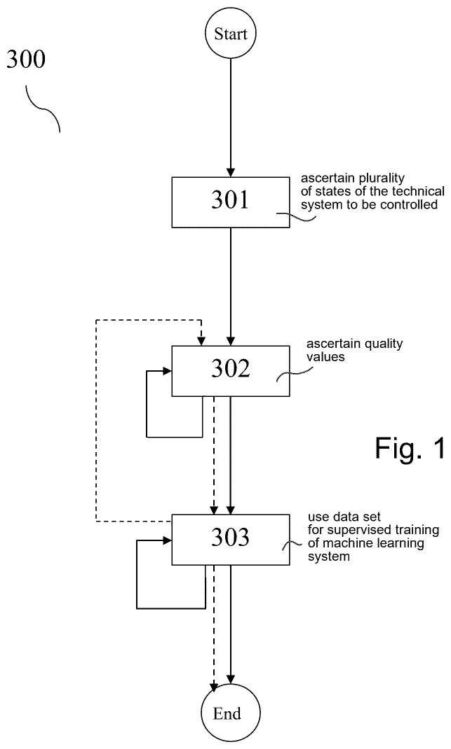

FIG. 1 schematically shows the sequence of a method (300) for training a machine learning system, wherein, after training, the machine learning system can be used in a model-predictive control of a technical system.

In a first step (301), a plurality of states of the technical system to be controlled is ascertained. The states can preferably be ascertained by operating the technical system in which at least one state of the system is ascertained at different times of operation, preferably at regular intervals. A state can be understood in particular as an operating state and/or as an environmental state of the system. The plurality of states is preferably ascertained by means of a sensor, i.e., a state is preferably a result of a measurement by means of a sensor. Alternatively, a state can be ascertained on the basis of an indirect measurement. An indirect measurement can be understood as a measurement that is obtained from a physical measurement by means of a sensor or from a previous indirect measurement and is not directly recognizable from the numerical values of the measurement in the original measurement. For example, an environmental state of the system can characterize a position of an object in an environment of the system. For example, the object can be recorded as an image by means of a camera and the position of the object can be ascertained on the basis of object detection of the object within the image, intrinsic and extrinsic camera parameters. The image in this case can be understood as a direct measurement whose values are the pixel values of the image and the position of the object can be understood as an indirect measurement derived from the pixel values (the direct measurement).

In particular, a state can also characterize multiple physical properties. For example, a state can characterize positions of different objects in the environment of the system and/or a position of the system.

The plurality of states can additionally or alternatively also be ascertained on the basis of a simulation. For example, a physical model of the system can be provided, which then simulates progressions of states of the system. Alternatively or additionally, it is also possible to scan a state space via rasterization and to use the thus-ascertained states in the plurality of states.

Alternatively or additionally, it is also possible that states of the plurality of states are ascertained on the basis of a prototype of the system, a structurally identical or structurally similar system of the system.

For ascertained states, preferably for all ascertained states, quality values are ascertained in a second step (302), wherein a quality value characterizes a quality of a state with respect to a model-predictive control. The quality values are preferably ascertained on the basis of an optimization problem, wherein the optimization problem characterizes an optimal model-predictive control. The optimization problem is preferably described by the formula

$$V ( x ) = {min}_{u {.}_{\vert k} , x {.}_{\vert k} , ξ {.}_{\vert k}} J ( u {.}_{\vert k} , x {.}_{\vert k} , ξ {.}_{\vert k} )$$

$$and the N {x}_{0 \vert k} = x ( k ) ,$$

$${x}_{N \vert k} ∈ α {X}_{f}$$

$$α {X}_{f} ⊆ \{ x \vert {H}_{x} x < {h}_{x} ( 1 - η ) + {ξ}_{N \vert k} \} ,$$

$$0 \leq α \leq 1 ,$$

$$∀ i ∈ \{ 0 , … N - 1 \} :$$

$$0 \leq {ξ}_{i \vert k} ,$$

$${x}_{i + 1 \vert k} = {Ax}_{i \vert k} + {Bu}_{i \vert k} ,$$

$${H}_{u} {u}_{i \vert k} \leq {h}_{u} ,$$

$${H}_{x} {x}_{i \vert k} \leq {h}_{x} ( 1 - η ) + {ξ}_{i \vert k} + {ξ}_{N \vert k} .$$

Starting from a current state x, the optimization variables are: the sequence of control signals of the system u._{|k}={u_{i|k}}ᵢ₌₀^{N-1} that was determined by the model-predictive control, the sequence of subsequent states x._{|k}={x_{i|k}}ᵢ₌₀^{N} that was predicted from the sequence of control signals, and a sequence of optional but preferred slack variables ξ._{|k}={ξi|k}ᵢ₌₀^{N} with which the secondary conditions of the optimization problem can be relaxed. The cost function J is preferably characterized by the formula

$$J ( u {.}_{\vert k} , x {.}_{\vert k} , ξ {.}_{\vert k} ) = {x}^{T} Px + ρ ‖ {ξ}_{N \vert k} ‖ + {\sum }_{i = 0}^{N - 1} l ( {x}_{i \vert k} , {u}_{i \vert k} ) + ρ ‖ {ξ}_{i \vert k} + {ξ}_{N \vert k} ‖ ,$$

$$l ( x , u ) = {x}^{T} Qx + {u}^{T} Ru .$$

The matrices Hᵤ, Hₓ, Q and R are hyperparameters of the optimization problem. The subscript |k indicates that reference is made to a point in time from a point in time k. For example, x_{i|k} is the predicted state for the point in time i, predicted at the point in time k. The secondary condition Hᵤu_{i|k}≤hᵤ characterizes a limitation of the control signal at any point in time i from the point in time k. The secondary condition

$${H}_{x} {x}_{i \vert k} \leq {h}_{x} ( 1 - η ) + {ξ}_{i \vert k} + {ξ}_{N \vert k}$$

represents a preferred secondary condition that further amplifies a limitation hₓ of a state x_{i|k} via the factor η. The factors η and ρ can be understood as interacting hyperparameters that weigh the degree of relaxation of the optimization problem (via ρ) against a robustness in relation to the approximation error (via η). The formula x_{i+1|k}=Ax_{i|k}+Bu_{i|k} characterizes a linear model of the system to be controlled, which model predicts a state transition from a point in time i to a subsequent point in time i+1 on the basis of a current state x_{i|k} and a control signal u_{i|k}, i.e., predicts the subsequent state. The variable N characterizes the prediction horizon of the model-predictive control; in other words, how far the model-predictive control looks into the future.

In the exemplary embodiment, the states are standardized in such a way that each state can characterize a deviation from a desired state. In other words, the goal of optimization can in particular be to achieve a state that corresponds to the zero vector. Control to other states is also possible. For example, with a suitable transformation, a desired state can be transformed in such a way that the transformed state is controlled to the zero vector and the control point is thus overall ascertained through the transformation.

For each of the ascertained states, a quality value as the result of the optimization with respect to a state can be ascertained by means of the optimization problem. Preferably, a quality value is thus ascertained for all ascertained states, wherein a data set is ascertained that comprises pairs of states and associated quality values.

This data set can be used in a third step (303) for supervised training of the machine learning system.

Optionally, it is also possible for the machine learning system (60) to be trained in batches using an iterative method (batched training). In this case, a subset of states can also be ascertained from the set of states and a quality value can be ascertained for each state for the subset thus ascertained (this optional embodiment is indicated by dashed lines in FIG. 1).

Preferably, the machine learning system (60) is trained at least until an approximation quality criterion is met, wherein the approximation quality criterion characterizes a magnitude of a difference between a value ascertained for a state by the value function and a value ascertained for the state by the machine learning system. In particular, the approximation quality criterion can be characterized by the formulas

$$∀ x ∈ X : 4 ‖ \tilde{V} ( x ) - V ( x ) ‖ + {V}_{max} \leq η \cdot ρ ,$$

$${V}_{max} = N ( ‖ Q ‖ \cdot ‖ X ‖ + ‖ R ‖ \cdot ‖ U ‖ ) + ‖ Q ‖ \cdot ‖ X ‖ ,$$

$$‖ X ‖ = {max}_{x ∈ X} ‖ x ‖ ,$$

$$‖ U ‖ = {max}_{u ∈ U} ‖ u ‖ ,$$

where \tilde{V}(x) is the prediction of the machine learning system (60) for state x. Preferably, the quality criterion can also be simplified and, instead of considering all states (characterized by the expression ∀x), a subset of states of the state space can be selected. For example, the subset can be ascertained by rasterizing the state space.

Alternatively, it is also possible for the machine learning system (60) to be configured to ascertain a first quality value and a second quality value. In this example, the data set can be divided in particular in such a way that, after the optimization described above for a specific state, a first part of the value function is provided as a first quality value, wherein the first part comprises the terms of the value function which in each case do not comprise slack variables, and a second part of the value function is provided as a second quality value, wherein the second part comprises terms of the value function which in each case comprise slack variables. With respect to the preferred optimization problem and the function J, the quality value can preferably be ascertained according to the formula

$${V}^{p e r f} ( x ) = {x}^{T} P x + {\sum }_{i = 0}^{N - 1} l ( {x}_{i \vert k} , {u}_{i \vert k} ) ,$$

where the value x represents the value ascertained by optimizing V(x).

The second quality value can preferably be described by the formula

$${V}^{slack} ( x ) = ρ ‖ {ξ}_{N \vert k} ‖ + {\sum }_{i = 0}^{N - 1} ρ ‖ {ξ}_{i \vert k} + {ξ}_{N \vert k} ‖ ,$$

where x again represents the value ascertained by optimizing V(x).

The data set can thus comprise tuples of state, first and second quality values:

$$𝒟 = {\{ ( {x}^{( j )} , {{V}^{perf} ( x )}^{( j )} , {{V}^{slack} ( x )}^{( j )} ) \}}_{j = {1}^{′}}^{n} ,$$

where n characterizes the number of data points in the data set. Alternatively, it is also possible to divide the data set into two data sets:

$${𝒟}^{perf} = {\{ ( {x}^{( j )} , {{V}^{perf} ( x )}^{( j )} ) \}}_{j = {1}^{′}}^{n} ,$$

$${𝒟}^{slack} = {\{ ( {x}^{( j )} , {{V}^{slack} ( x )}^{( j )} ) \}}_{j = 1}^{n} .$$

The machine learning system can then be trained on the basis of the two loss functions

$${ℒ}^{perf} = \frac{1}{n} {\sum }_{( x , y ) ∈ {D}^{perf}} {‖ {\hat{V}}^{perf} ( x ) - y ‖}_{2}^{2} ,$$

$${ℒ}^{slack} = \frac{1}{n} {\sum }_{( x , y ) ∈ {D}^{slack , +}} {‖ {\hat{V}}^{slack} ( x ) - y ‖}_{2}^{2} + {\sum }_{( x , y ) ∈ {D}^{slack , 0}} c \cdot max ( 0 , {\hat{V}}^{slack} ( x ) ) ,$$

where \hat{V}^{perf}(x) is the prediction of the machine learning system (60) with respect to the first quality value, \hat{V}^{slack}(x) is the prediction of the machine learning system (60) with respect to the second quality value, c is a positive hyperparameter of the training method, D^{slack,+}={(x, y)∈D^{slack}|y>0} and D^{slack,+}={(x,y)∈D^{slack}|y=0}.

The use of the two loss functions advantageously completely avoids the problem of learning rapidly changing values of \hat{V}^{slack}(x) when transitioning from slack variables equal to zero to slack variables greater than zero. This is achieved in that the machine learning system (60) can even predict negative values for the second quality value. These negative values can be easily filtered out in a later control by the complete result of the value function being approximated by the formula

$$V ( x ) \approx {\hat{V}}^{perf} ( x ) + max ( 0 , {\hat{V}}^{slack} ( x ) ) .$$

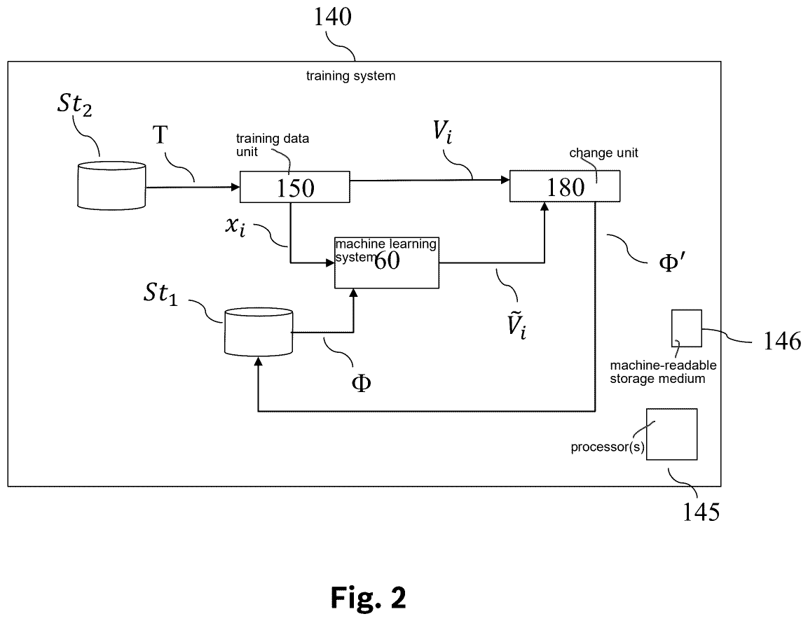

FIG. 2 shows an exemplary embodiment of a training system (140), which is configured to carry out the third step (303) of the method (300) shown in FIG. 1. The machine learning system (60) is trained by means of a training data set (T) that comprises tuples of states (xᵢ) and associated quality values (Vᵢ).

For the training, a training data unit (150) accesses a computer-implemented database (St₂), wherein the database (St₂) provides the training data set (T). The training data unit (150) ascertains from the training data set (T), preferably randomly, at least one state (xᵢ) and the quality value (Vᵢ) corresponding to the state (xᵢ), and transmits the state (xᵢ) to the machine learning system (60). On the basis of the state (xᵢ), the machine learning system (60) ascertains a prediction (\tilde{V}ᵢ) of the quality value (Vᵢ).

The quality value (Vᵢ) and the prediction (\tilde{V}ᵢ) are transmitted to a change unit (180).

On the basis of the quality value (Vᵢ) and the prediction (\tilde{V}ᵢ), the change unit (180) then ascertains new parameters (Φ′) for the machine learning system (60). For this purpose, the change unit (180) compares the quality value (Vᵢ) and the prediction (\tilde{V}ᵢ) by means of a loss function. The loss function ascertains a first loss value that characterizes to what extent the quality value (Vᵢ) deviates from the prediction (\tilde{V}ᵢ). In the exemplary example, a function that characterizes a quadratic distance of the quality value (Vᵢ) from the prediction (\tilde{V}ᵢ) is selected as the loss function. In alternative exemplary embodiments, other loss functions are also possible.

The change unit (180) ascertains the new parameters (Φ′) on the basis of the first loss value. In the exemplary embodiment, this is done using a gradient descent method, preferably Stochastic Gradient Descent, Adam, or AdamW. In further exemplary embodiments, the training can also be based on an evolutionary algorithm or second-order optimization.

The new parameters (Φ′) ascertained are stored in a model parameter memory (St₁). Preferably, the ascertained new parameters (Φ′) are provided as parameters (Φ) to the machine learning system (60).

In further, preferred exemplary embodiments, the described training is repeated iteratively for a predefined number of iteration steps or repeated iteratively until the first loss value falls below a predefined threshold value. Alternatively or additionally, it is also possible that the training is terminated when an average first loss value for a test or validation data set falls below a predefined threshold value. In at least one of the iterations, the new parameters (Φ′) ascertained in a previous iteration are used as parameters (Φ) of the machine learning system (60).

Furthermore, the training system (140) may comprise at least one processor (145) and at least one machine-readable storage medium (146) containing instructions that, when executed by the processor (145), cause the training system (140) to perform a training method according to one of the aspects of the present invention.

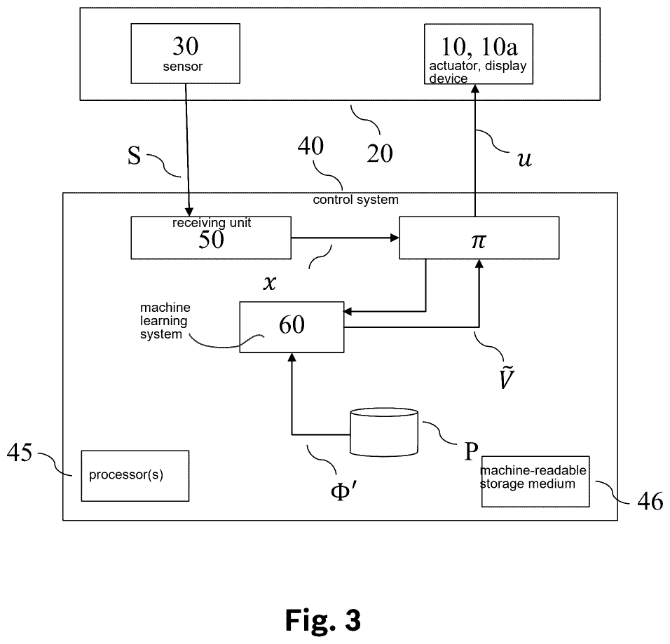

FIG. 3 shows a control system (40) which uses the machine learning system (60) to generate control signals (u) of a system. In the exemplary embodiment, the control signal (u) represents a control signal for an actuator (10) or a display device (10a) of the technical system. At preferably regular time intervals, at least one operating state and/or environmental state of the technical system is recorded in a sensor (30), which can also be provided by a plurality of sensors. The sensor signal (S) of the sensor (30), or, in the case of a plurality of sensors, one sensor signal (S) each, is transmitted to the control system (40). The control system (40) thus receives a sequence of sensor signals (S). The control system (40) ascertains control signals (u) therefrom, which are transmitted to the actuator (10).

The control system (40) receives the sequence of sensor signals (S) from the sensor (30) in an optional receiving unit (50), which converts the sequence of sensor signals (S) into a sequence of states (x) (alternatively, the sensor signal (S) can also be adopted directly as the state (x)). The state (x) can, for example, be a section or a further processing of the sensor signal (S) or can ascertain the state (x) on the basis of the sensor signal (S) by means of an indirect measurement. In other words, the state (x) is ascertained depending on the sensor signal (S). The state (x) is transmitted to a control law module (7).

The control law module (π) ascertains the control signal (u) on the basis of the state (x) and the machine learning system (60). The control module ascertains the control signal (u) preferably on the basis of a control law which is preferably characterized by the formula

$$π ( x ) = {arg min}_{u ∈ U} {u}^{T} Ru + \hat{V} ( f ( x , u ) ) .$$

The term \tilde{V}(f(x,u)) characterizes a prediction (\tilde{V}) of a quality value (V) of the state that is reached when the control signal u is executed in the state x; in other words, the quality of a state that is reached when a control signal u is executed in the state x.

If a machine learning system (60) which predicts a first quality value and a second quality value as described above is to be used for the control, \tilde{V}(f(x,u) can preferably be ascertained by the formula

$$\hat{V} ( f ( x , u ) ) = {\hat{V}}^{perf} ( f ( x , u ) ) + max ( 0 , {\hat{V}}^{slack} ( f ( x , u ) ) ) .$$

The state that is reached is preferably ascertained by the same model

$$x ( k + 1 ) = f ( x ( k ) , u ( k ) ) = A x ( k ) + B x ( k )$$

which has already been used to determine the quality value (Vᵢ). The prediction \tilde{V} is carried out by the machine learning system (60). In other words, a quality value is predicted by means of the machine learning system (60) for the subsequent state predicted by the linear model.

The control law includes a preferred term u^{T}Ru, which additionally ensures that reaching a subsequent state with the highest quality value is weighed against the control signal to be applied (u). The matrix R represents a hyperparameter that can preferably be omitted or set to the unit matrix. The optimization problem can be solved, for example, with derivation-free and/or parallelizable methods such as sampling or rasterization of the search space U of the possible control signals (u). A solution to the optimization problem is then provided as a control signal (u) to the actuator (10) and/or the display device (10a).

The machine learning system (60) is preferably parametrized by parameters (Φ) that are stored in a parameter memory (P) and are provided by the latter.

The actuator (10) receives the control signals (A), is controlled accordingly and performs a corresponding action. Here, the actuator (10) can comprise a control logic (not necessarily structurally integrated), which ascertains, from the control signal (A), a second control signal with which the actuator (10) is then controlled.

In further embodiments, the control system (40) comprises the sensor (30). In still further embodiments, the control system (40) alternatively or additionally also comprises the actuator (10).

In further preferred embodiments, the control system (40) comprises at least one processor (45) and at least one machine-readable storage medium (46) on which instructions are stored that, when executed on the at least one processor (45), cause the control system (40) to perform the method according to the present invention.

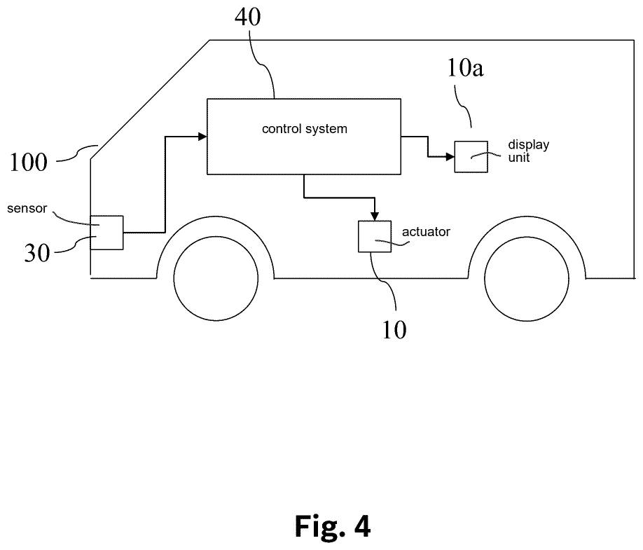

FIG. 4 shows how the control system (40) can be used to control an at least partially autonomous robot, here an at least partially autonomous motor vehicle (100).

The sensor (30) can, for example, be a video sensor preferably arranged in the motor vehicle (100). The conversion unit (50) can in particular be configured such that it ascertains a drivable area, for example a road or a lane of a multi-lane road. The state (x) can then in particular characterize a deviation of the robot (100) from a desired position on the drivable area, for example a deviation of a center point of the robot from a center point of the drivable area. The state (x) can additionally comprise longitudinal and lateral accelerations of the robot. The state can additionally characterize a slip of a means of locomotion of the robot, e.g., of a tire or a chain of the robot. Furthermore, it is possible for the state to comprise a position of other objects, for example road users, in the environment of the robot (100). The optimization problem that was solved for the training of the machine learning system (60) may then in particular contain secondary conditions that characterize a minimum distance of the robot to other objects.

The actuator (10), which is preferably arranged in the robot (100), can, for example, be a brake, a drive or a steering system of the robot (100). The control signal (A) can then be ascertained in such a way that the actuator or actuators (10) are controlled such that the robot (100) moves, for example, along the center line of the drivable area. In addition, it is possible for the actuator(s) (10) to be controlled in such a way that a collision with other objects in the environment of the robot (100) is avoided.

Alternatively or additionally, the control signal (A) can be used to control the display unit (10a) and, for example, to display the identified objects and/or to display the planned driving trajectory of the robot (100).

Alternatively, the at least partially autonomous robot can be another mobile robot (not shown), for example one that moves by flying, swimming, diving or walking. The mobile robot can, for example, be an at least partially autonomous lawnmower or an at least partially autonomous cleaning robot. In these cases as well, the control signal (A) can be ascertained in such a way that the drive and/or steering system of the mobile robot are controlled in such a way that the at least partially autonomous robot prevents, for example, a collision with objects identified by the machine learning system (60).

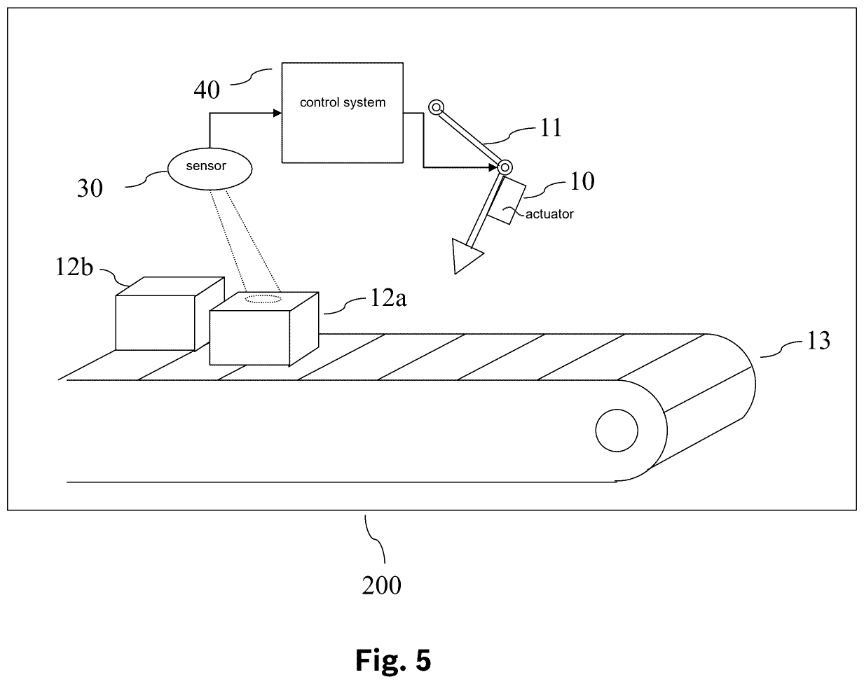

FIG. 5 shows an exemplary embodiment in which the control system (40) is used to control a manufacturing machine (11) of a manufacturing system (200) by controlling an actuator (10) controlling the manufacturing machine (11). The manufacturing machine (11) may, for example, be a machine for punching, sawing, drilling and/or cutting. Furthermore, it is possible that the manufacturing machine (11) is designed to grip a manufactured product (12a, 12b) by means of a gripper.

The sensor (30) can in this case, for example, be a video sensor which detects, for example, the conveying surface of a conveyor belt (13), wherein manufactured products (12a, 12b) can be located on the conveyor belt (13).

The state (x) can in particular comprise a position of a manufactured product (12a, 12b) and a position of a machining tool of the manufacturing machine (11), e.g., a position of a gripper. The actuator (10) controlling the manufacturing machine (11) can then be controlled depending on the ascertained positions of the manufactured products (12a, 12b). For example, the actuator (10) can be controlled in such a way that it punches, saws, drills and/or cuts a manufactured product (12a, 12b) at a predetermined location on the manufactured product (12a, 12b).

Furthermore, it is possible that the machine learning system (60) is designed to ascertain further properties of a manufactured product (12a, 12b) alternatively or in addition to the position. In particular, it is possible that the machine learning system (60) ascertains whether a manufactured product (12a, 12b) is defective and/or damaged. In this case, the actuator (10) can be controlled in such a way that the manufacturing machine (11) rejects a defective and/or damaged manufactured product (12a, 12b).

The term “computer” includes any device for processing specifiable calculation rules. These calculation rules can be in the form of software, or in the form of hardware, or even in a mixed form of software and hardware.

In general, a plurality can be understood as indexed, i.e., each element of the plurality is assigned a unique index, preferably by assigning consecutive integers to the elements contained in the plurality. Preferably, when a plurality comprises N elements, where N is the number of elements in the plurality, the elements are assigned integers from 1 to N.

1-21. (canceled)

22. A computer-implemented method, comprising:
training a machine learning system for a model-predictive control of a technical system, wherein the machine learning system is configured, with respect to an operating state and/or an environmental state of the technical system to be controlled, to ascertain a first quality value that characterizes a quality of the state, wherein the training includes the following steps:
ascertaining a plurality of operating states of the technical system to be controlled and/or environmental states of the technical system to be controlled;
ascertaining a first quality value (Vᵢ, Vᵢ^{perf}) of a state (xᵢ) of the plurality of operating states and/or environmental states, wherein the first quality value (Vᵢ, Vᵢ^{perf}) characterizes a quality of the state (xᵢ) with respect to a model-predictive control; and
training the machine learning system through supervised training of the machine learning system, wherein the state (xᵢ) is used as input of the machine learning system and the ascertained first quality value (Vᵢ, Vᵢ^{perf}) is used as a desired output of the machine learning system.

23. The method according to claim 22, wherein the first quality value (Vᵢ, Vᵢ^{perf}) is ascertained based on a value function of the model-predictive control, wherein the value function ascertains a quality of the state (xᵢ) with respect to a state (xᵢ) and the value function further includes secondary conditions, wherein a secondary condition characterizes a physical limitation of the state and/or a secondary condition characterizes a limitation of a control signal which the model-predictive control can select.

24. The method according to claim 23, wherein the value function characterizes the result of an optimization of a cost function under the secondary conditions.

25. The method according to claim 23, wherein the value function includes a secondary condition that permits a numerical deviation of a state (xᵢ) from a physical limitation using a slack variable.

26. The method according to claim 25, wherein the secondary condition further provides a factor that amplifies a physical limitation of the state.

27. The method according to claim 23, wherein the value function is described by the following formula:
$$V ( x ) = {min}_{u {.}_{\vert k} , x {.}_{\vert k} , ξ {.}_{\vert k}} J ( u {.}_{\vert k} , x {.}_{\vert k} , ξ {.}_{\vert k} )$$
$$and the N {x}_{0 \vert k} = x ( k ) ,$$
$${x}_{N \vert k} ∈ α {X}_{f}$$
$$α {X}_{f} ⊆ \{ x \vert {H}_{x} x < {h}_{x} ( 1 - η ) + {ξ}_{N \vert k} \} ,$$
$$0 \leq α \leq 1 ,$$
$$∀ i ∈ \{ 0 , … N - 1 \} : 0 \leq {ξ}_{i \vert k} ,$$
$${x}_{i + 1 \vert k} = {Ax}_{i \vert k} + {Bu}_{i \vert k} ,$$
$${H}_{u} {u}_{i \vert k} \leq {h}_{u} ,$$
$${H}_{x} {x}_{i \vert k} \leq {h}_{x} ( 1 - η ) + {ξ}_{i \vert k} + {ξ}_{N \vert k} ,$$
where a function J is described by the following formula:
$$J ( u {.}_{\vert k} , x {.}_{\vert k} , ξ {.}_{\vert k} ) = {x}^{T} P x + ρ ‖ {ξ}_{N \vert k} ‖ + {\sum }_{i = 0}^{N - 1} l ( {x}_{i \vert k} , {u}_{i \vert k} ) + ρ ‖ {ξ}_{i \vert k} + {ξ}_{N \vert k} ‖ .$$

28. The method according to claim 23, wherein the first quality value (Vᵢ) corresponds to a result of the value function at a location of the state (xᵢ).

29. The method according to claim 25, wherein the first quality value (Vᵢ^{perf}) corresponds to a first part of the value function at the location of the state (xᵢ), wherein the first part does not contain any slack variables, and the machine learning system furthermore ascertains a second quality value (Vᵢ^{slack}) wherein the second quality value (Vᵢ^{slack}) corresponds to a second part of the value function at the location of the state (xᵢ) which contains slack variables, and, in the training step, the second quality value (Vᵢ^{slack}) is used as another desired output of the machine learning system.

30. The method according to claim 28, wherein the value function is described by the following formula:
$$V ( x ) = {min}_{u {.}_{\vert k} , x {.}_{\vert k} , ξ {.}_{\vert k}} J ( u {.}_{\vert k} , x {.}_{\vert k} , ξ {.}_{\vert k} )$$
$$and the N {x}_{0 \vert k} = x ( k ) ,$$
$${x}_{N \vert k} ∈ α {X}_{f}$$
$$α {X}_{f} ⊆ \{ x \vert {H}_{x} x < {h}_{x} ( 1 - η ) + {ξ}_{N \vert k} \} ,$$
$$0 \leq α \leq 1 ,$$
$$∀ i ∈ \{ 0 , … N - 1 \} : 0 \leq {ξ}_{i \vert k} ,$$
$${x}_{i + 1 \vert k} = A {x}_{i \vert k} + {Bu}_{i \vert k} ,$$
$${H}_{u} {u}_{i \vert k} \leq {h}_{u} ,$$
$${H}_{x} {x}_{i \vert k} \leq {h}_{x} ( 1 - η ) + {ξ}_{i \vert k} + {ξ}_{N \vert k} ,$$
where a function J is described by the following formula:
$$J ( u {.}_{\vert k} , x {.}_{\vert k} , ξ {.}_{\vert k} ) = {x}^{T} P x + ρ ‖ {ξ}_{N \vert k} ‖ + {\sum }_{i = 0}^{N - 1} l ( {x}_{i \vert k} , {u}_{i \vert k} ) + ρ ‖ {ξ}_{i \vert k} + {ξ}_{N \vert k} ‖ .$$
wherein the first quality value is described by the formula:
$${V}^{perf} ( x ) = {x}^{T} P x + {\sum }_{i = 0}^{N - 1} l ( {x}_{i \vert k} , {u}_{i \vert k} )$$
and the second quality value is described by the formula
$${V}^{slack} ( x ) = ρ ‖ {ξ}_{N \vert k} ‖ + {\sum }_{i = 0}^{N - 1} ρ ‖ {ξ}_{i \vert k} + {ξ}_{N \vert k} ‖ .$$

31. The method according to claim 29, wherein the machine learning system includes two machine learning models, each of which including a neural network, wherein a first model of the two models is configured to predict the first quality value (Vᵢ^{perf}) based on the state (xᵢ) as input of the first model and a second model of the two models is configured to predict the second quality value (Vᵢ^{slack}) based on the state (xᵢ) as input of the second model.

32. The method according to claim 29, wherein the machine learning system includes a machine learning model which includes a neural network, wherein the model is configured to predict the first quality value (Vᵢ^{perf}) and the second quality value (Vᵢ^{slack}).

33. The method according to claim 31, wherein the machine learning system is trained based on a first loss function and a second loss function, wherein the first loss function characterizes a difference between a prediction of the first quality value and the first quality value (Vᵢ^{perf}) and the second loss function characterizes a difference between the prediction of the second quality value and the second quality value (Vᵢ^{slack}).

34. The method according to claim 33, wherein the second loss function is given by the formula:
$${ℒ}^{slack} = {\sum }_{( x , y ) ∈ {D}^{slack , +}} {‖ {\hat{V}}^{slack} ( x ) - y ‖}_{2}^{2} + {\sum }_{( x , y ) ∈ {D}^{slack , 0}} c \cdot max ( 0 , {\hat{V}}^{slack} ( x ) ) .$$

35. The method according to claim 23, wherein, in the training step, the machine learning system is trained at least until an approximation quality criterion is met, wherein the approximation quality criterion characterizes a magnitude of a difference between a value ascertained for a state by the value function and at least one value of a first and/or a second value that was ascertained for the state by the machine learning system.

36. The method according to claim 22, further comprising:
model-predictive controlling the technical system, including:
ascertaining an operating state and/or environmental state of the system;
ascertaining a control signal for the technical system, wherein the control signal is ascertained based on a control law (π), wherein the control law (π) includes a term \tilde{V}(f(x,u)), where \tilde{V} characterizes an output of the trained machine learning system when it receives the input f(x, u), where f is a model of the system and predicts a next operating state and/or system state of the system based on the ascertained operating state and/or environmental state x and a control signal u; and
controlling the system using the ascertained control signal.

37. The method according to claim 30, further comprising:
model-predictive controlling of the technical system, including:
ascertaining an operating state and/or environmental state of the system;
ascertaining a control signal for the technical system, wherein the control signal is ascertained based on a control law (π), wherein the control law (π) includes a term \tilde{V}(f(x,u)), wherein V is ascertained according to the formula \hat{V}(f(x,u))=\hat{V}^{perf} (f(x, u))+max(0, \hat{V}ᵢ^{slack}(f(x u)), where \hat{V}^{perf}(f(x, u)) characterizes a first quality value output by the trained machine learning system for the input f(x, u) and \hat{V}^{slack}(f(x, u)) characterizes a second quality value output by the machine learning system for the same input, where f is a model of the technical system and predicts a next operating state and/or system state of the technical system based on the ascertained operating state and/or environmental state x and a control signal u.

38. The method according to claim 26, wherein the control law further includes a term characterizing a magnitude of the control signal.

39. A training device configured to train a machine learning system for a model-predictive control of a technical system, wherein the machine learning system is configured, with respect to an operating state and/or an environmental state of the technical system to be controlled, to ascertain a first quality value that characterizes a quality of the state, wherein training device configured to:
ascertain a plurality of operating states of the technical system to be controlled and/or environmental states of the technical system to be controlled;
ascertain a first quality value (Vᵢ, Vᵢ^{perf}) of a state (xᵢ) of the plurality of operating states and/or environmental states, wherein the first quality value (Vᵢ, Vᵢ^{perf}) characterizes a quality of the state (xᵢ) with respect to a model-predictive control; and
train the machine learning system through supervised training of the machine learning system, wherein the state (xᵢ) is used as input of the machine learning system and the ascertained first quality value (Vᵢ, Vᵢ^{perf}) is used as a desired output of the machine learning system.

40. A control system configured to model-predictive controlling a technical system, the control system configured to:
ascertain an operating state and/or environmental state of the system;
ascertain a control signal for the technical system, wherein the control signal is ascertained based on a control law (π), wherein the control law (π) includes a term V(f (x, u)), where V characterizes an output of a trained machine learning system when it receives the input f(x, u), where f is a model of the system and predicts a next operating state and/or system state of the system based on the ascertained operating state and/or environmental state x and a control signal u; and
control the system using the ascertained control signal.

41. The control system according to claim 40, wherein the machine learning system is configured, with respect to an operating state and/or an environmental state of the technical system to be controlled, to ascertain a first quality value that characterizes a quality of the state, wherein the training of the machine learning system includes:
ascertaining a plurality of operating states of the technical system to be controlled and/or environmental states of the technical system to be controlled;
ascertaining a first quality value (Vᵢ, Vᵢ^{perf}) of a state (xᵢ) of the plurality of operating states and/or environmental states, wherein the first quality value (Vᵢ, Vᵢ^{perf}) characterizes a quality of the state (xᵢ) with respect to a model-predictive control; and
training the machine learning system through supervised training of the machine learning system, wherein the state (xᵢ) is used as input of the machine learning system and the ascertained first quality value (Vᵢ, Vᵢ^{perf}) is used as a desired output of the machine learning system.

42. A non-transitory machine-readable storage medium on which is stored a computer program for training a machine learning system for a model-predictive control of a technical system, wherein the machine learning system is configured, with respect to an operating state and/or an environmental state of the technical system to be controlled, to ascertain a first quality value that characterizes a quality of the state, the computer program, when executed by a processor, causing the processor to perform the following steps:
ascertaining a plurality of operating states of the technical system to be controlled and/or environmental states of the technical system to be controlled;
ascertaining a first quality value (Vᵢ, Vᵢ^{perf}) of a state (xᵢ) of the plurality of operating states and/or environmental states, wherein the first quality value (Vᵢ, Vᵢ^{perf}) characterizes a quality of the state (xᵢ) with respect to a model-predictive control; and
training the machine learning system through supervised training of the machine learning system, wherein the state (xᵢ) is used as input of the machine learning system and the ascertained first quality value (Vᵢ, Vᵢ^{perf}) is used as a desired output of the machine learning system.
